(19) United States
(12) Patent Application Publication
(10) Pub. No.: US 2013/0170245 A1
(43) Pub. Date: Jul. 4, 2013

(54) LIGHTING DEVICE

(71) Applicant: SAMSUNG ELECTRONICS CO., LTD., Suwon-si (KR)

(72) Inventors: Jong Pa HONG, Yongin-si (KR); Gwan Su LEE, Hwaseong-si (KR); Jin Hyuk SONG, Incheon (KR); Joong Kon SON, Seoul (KR)

(73) Assignee: SAMSUNG ELECTRONICS CO., LTD., Suwon-si (KR)

(21) Appl. No.: 13/731,465

(22) Filed: Dec. 31, 2012

(30) Foreign Application Priority Data
Dec. 30, 2011 (KR) 10-2011-0147248

(51) Int. Cl. F21V 8/00

(52) U.S. Cl. CPC G02B 6/0001
USPC 362/555

(57) ABSTRACT

A lighting device improves light distribution uniformity. When a light emitting diode (LED) package module is applied to a straight-tube fluorescent lamp, characteristics of a circular surface light source with the LED may be efficiently embodied by varying a refractive index of a light guide member based on positions of the light guide member.

### CROSS-REFERENCE TO RELATED APPLICATION

This application claims the benefit of Korean Patent Application No. 10-2011-0147248, filed on Dec. 30, 2011, in the Korean Intellectual Property Office, the disclosure of which is incorporated herein by reference.

### BACKGROUND

1. Field

Embodiments relate to a lighting device. More particularly, embodiments relate to a lighting device for improving light distribution uniformity.

2. Description of the Related Art

A light emitting diode (LED) is a semiconductor device that emits light in a direction of a current flow. In other words, the LED is an electronic part that converts electric energy to light energy. The LED is a p-n junction diode, including a gallium arsenide (GaAs) and gallium nitride (GaN) light semiconductor.

Recently, a blue LED and an ultraviolet (UV) LED have been developed using a nitride having excellent physical and chemical characteristics. Since white light or other forms of monochromatic light can be produced using the blue LED or the UV LED and phosphor substances, a range of applications for the LED is expanding.

The LED has a relatively long life, small size, light weight, high directivity of light, and low-voltage operability. Furthermore, the LED is resistant against impact and vibration. The LED also does not need preheating and complicated driving. Therefore, the LED is applicable to many fields. For example, the range of applications for the LED has recently expanded to small-size lighting for a mobile terminal, general lighting for indoors and outdoors, vehicle lighting, a backlight unit for a large-area liquid crystal display (LCD), etc.

As the LED achieves a high output of light and a high efficiency, a lighting device employing the LED has been replacing general conventional lighting devices. However, an optical system is necessary, because the LED has a different type of light distribution, when compared to conventional lighting devices. In a case of a straight-tube fluorescent lamp, it is very difficult to embody characteristics of a circular surface light source with the LED.

### SUMMARY

An aspect of the embodiments provide a lighting device capable of embodying characteristics of a uniform and circular surface light source using a light emitting diode (LED).

Another aspect of the embodiments provides a lighting device with improved light distribution uniformity.

Still another aspect of the embodiments provides a lighting device which is applicable to various conditions of light distribution and improved in a degree of freedom in design.

According to an aspect of the embodiments, there is provided a lighting device including a device main body, a light emitting diode (LED) which is provided to at least one of both ends of an inside of the device main body, and a light guide member which is disposed between the both ends of the device main body to uniformly distribute light emitted from the LED to the outside, wherein a refractive index of the light guide member is reduced in a direction away from the LED.

The light guide member may be formed by bonding a plurality of light guide materials having different refractive indices.

For example, the LED may be disposed at the both ends of the device main body. The light guide member may include a first light guide material which is disposed at each end of the lighting device to receive the light emitted from the LED, and a second light guide material, disposed between the first light guide material disposed at each end of the lighting device, to be bonded to the first light guide material at each end of the lightning device, the second light guide material has a lower refractive index than the first light guide materials.

Alternatively, the LED may be disposed at the at least one end of the device main body, and the light guide member may include a first light guide material which is disposed at one end of the lighting device to receive the light emitted from the LED, a second light guide material which is bonded to one end of the first light guide material, the second light guide material having a lower refractive index than the first light guide materials, and a third light guide material bonded to an end of the second light guide material and disposed at an opposite end of the device main body, the third light guide material has a lower refractive index than the second light guide materials.

The light guide member may include an uneven surface portion disposed on a surface to diffuse or reflect the light to increase light distribution efficiency.

The light guide member may include at least one of a bubble body and a reflection body disposed at an inside of the light guide member to diffuse or reflect the light to increase light distribution efficiency.

The light guide member may include at least one of a bubble body and a reflection body disposed at an inside of the light guide member to diffuse or reflect light from the LED to increase light distribution efficiency of the light guide member, and at least one of the bubble body and the reflection body may be configured to have a density varying according to positions of the light guide member so that a refractive index is varied according to the positions of the light guide member.

The density of the at least one of the bubble body and the reflection body may be reduced in a direction away from the LED.

The light guide member may be sloped to have a reduced thickness in the direction away from the LED such that an effective refractive index is reduced in a direction away from the LED.

The light guide member may be provided in a conical shape or a polygonal pyramid shape.

The device main body may include a fluorescent tube which is configured to receive the LED and the light guide member inside, and a support member which is connected to the both ends of the fluorescent tube to support the light guide member. Here, the LED may be configured to emit monochromatic light, and a phosphor converts the monochromatic light to white light.

The fluorescent tube may include the phosphor. Alternatively, the phosphor may be provided in a layer form on a surface of the fluorescent tube.

According to another aspect of the embodiments, there is provided a lighting device including a device main body, a light emitting diode (LED) which is provided in at least one end of an inside of the device main body, and a light guide member which is disposed between both ends of the device main body to uniformly distribute light emitted from the LED to the outside. The device main body may include a fluorescent tube configured to receive the LED and the light guide member inside and provided with a phosphor for converting monochromatic light to white light, and a support member connected to the both ends of the fluorescent tube to support the light guide member.

The fluorescent tube may include the phosphor. Alternatively, the phosphor may be provided in form of a layer on a surface of the fluorescent tube.

According to a further aspect of the embodiments, there is provided a lightning device including a light emitting diode (LED), a light guide member which is configured to uniformly distribute light, an elongated cylinder which is configured to include the LED and the light guide member, a first support member which is connected to one end of the elongated cylinder to support the light guide member, and a second support member which is connected to an opposite end of the elongated cylinder as compared to the one end of the elongated cylinder, wherein the LED is disposed at the one end of the elongated cylinder.

In a lighting device according to embodiments, a refractive index of a light guide member is reduced in a direction away from an LED. Therefore, light may be evenly distributed throughout the light guide member. Accordingly, uniformity of light distribution of the lighting device may be increased. In particular, when the lighting device is applied to a direct-type fluorescent lamp, characteristics of a circular surface light source may be easily achieved.

According to embodiments, the lighting device includes the light guide member formed by bonding a plurality of materials having different refractive indices. Therefore, a light guide member, in which a refractive index is varied depending on positions, may be easily manufactured.

The lighting device according to embodiments includes an uneven surface portion formed on a surface of the light guide member, or includes a bubble body or a reflection body provided in the light guide member. Therefore, using diffusion and reflection of light, light distribution characteristics of the light guide member may be enhanced.

In addition, in the lighting device according to embodiments, the light guide member having various refractive indices, depending on positions, may be easily manufactured by adjusting a density of the bubble body or the reflection body provided in the light guide member.

The lighting device according to embodiments is structured such that a thickness of the light guide member is reduced, in a sloping manner in a direction away from the LED. Therefore, an effective refractive index of the light guide member may be easily varied according to a position. In particular, the effective refractive index may be easily controlled by adjusting an angle of a slope formed on the surface of the light guide member according to the position, or by varying gas injected to a space between the light guide member and a fluorescent tube.

Furthermore, the lighting device according to embodiments includes an LED that emits monochromatic light. The fluorescent tube, that includes a phosphor, converts the monochromatic light into white light. Accordingly, separation of white light from the light guide member may be prevented. As a result, stability of the light distribution may be increased.

### BRIEF DESCRIPTION OF THE DRAWINGS

These and/or other aspects, features, and advantages of the embodiments will become apparent and more readily appreciated from the following description of exemplary embodiments, taken in conjunction with the accompanying drawings of which:

FIG. 1 is a perspective view illustrating a lighting device according to an embodiment;

FIG. 2 is a diagram illustrating a structure of the lighting device shown in FIG. 1;

FIG. 3 is a sectional view illustrating an example of a light guide member shown in FIG. 2;

FIG. 4 is a sectional view illustrating another example of the light guide member shown in FIG. 2;

FIG. 5 is a cross-sectional view illustrating yet another example of the light guide member shown in FIG. 2;

FIG. 6 is a cross-sectional view illustrating a lighting device according to another embodiment;

FIG. 7 is a cross-sectional view illustrating a lighting device according to yet another embodiment;

FIG. 8 is a cross-sectional view illustrating a lighting device according to still another embodiment; and

FIG. 9 is a sectional view illustrating a light guide member shown in FIG. 8.

### DETAILED DESCRIPTION

Reference will now be made in detail to exemplary embodiments, examples of which are illustrated in the accompanying drawings, wherein like reference numerals refer to the like elements throughout. However, aspects are not limited by the exemplary embodiments.

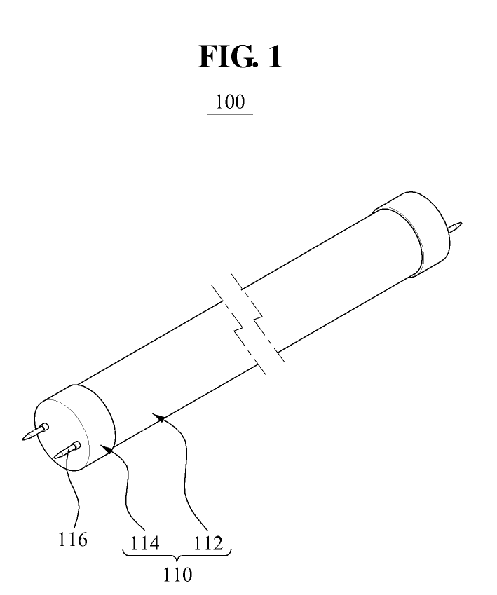

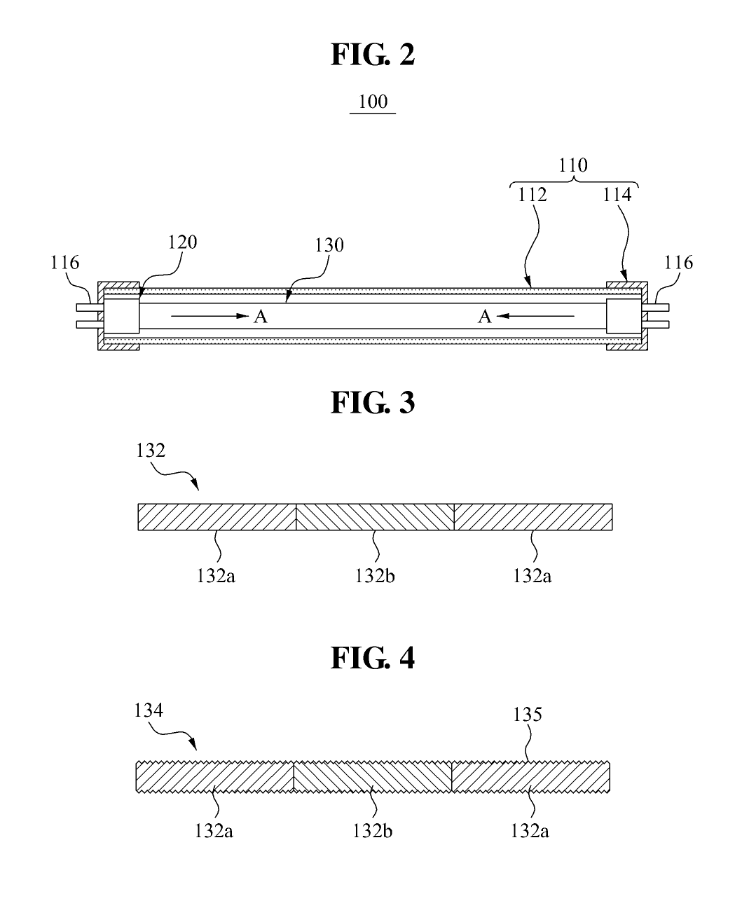

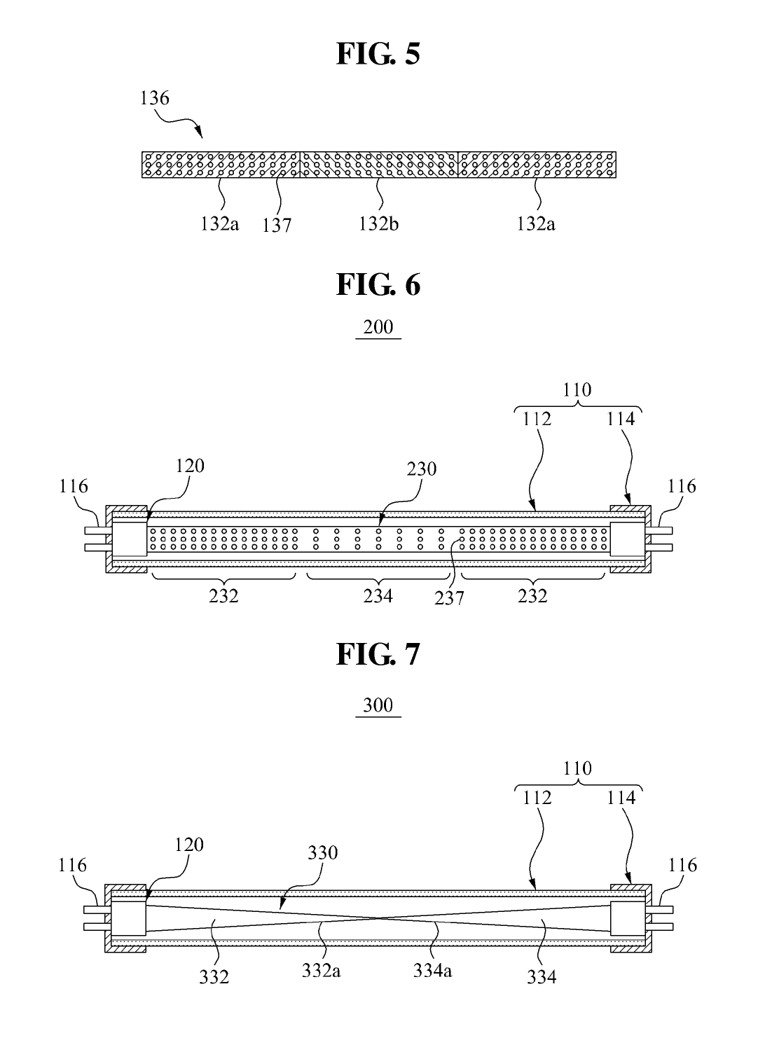

FIG. 1 is a perspective view illustrating a lighting device 100 according to an embodiment. FIG. 2 illustrates a structure of the lighting device 100 shown in FIG. 1. FIG. 3 is a sectional view illustrating an example of a light guide member 130 shown in FIG. 2. FIG. 4 is a sectional view illustrating another example of the light guide member 130 shown in FIG. 2. FIG. 5 is a cross-sectional view illustrating yet another example of the light guide member 130 shown in FIG. 2.

Referring to FIGS. 1 and 2, the lighting device 100 includes a device main body 110, a light emitting diode (LED) 120, and the light guide member 130.

The device main body 110 may include a fluorescent tube 112 and a support member 114.

The fluorescent tube 112 has a tubular shape to receive the LED 120 and the light guide member 130. Hereinafter, the fluorescent tube 112 will be described to have a form of an elongated cylinder, although a form of the tube is not limited thereto. The shape of the fluorescent tube 112 may be varied according to design conditions of the lighting device 100.

The fluorescent tube 112 may be made of a transparent material to allow transmission of light emitted from the light guide member 130. For example, the fluorescent tube 112 may be made of transparent glass or plastic.

A phosphor (not shown) to convert monochromatic light of the LED 120 into white light may be provided in the fluorescent tube 112. In other words, when the LED 120 is designed to generate monochromatic light, as will be described hereinafter, the phosphor of the fluorescent tube 112 may generate white light through a reaction with the monochromatic light emitted from the light guide member 130.

When the phosphor is disposed as aforementioned, the phosphor and the LED 120 may be set apart from each other by a predetermined distance. Accordingly, damage to the phosphor by heat of the LED 120 may be prevented. Also, the light passed through the light guide member 130 may be more uniformly distributed as passing through the fluorescent tube 112. Furthermore, since a light beam emitted through the fluorescent tube 112 is uniformly distributed, a hot spot of the lighting device 100 may not be generated.

Light beams having different color temperatures may be provided by controlling a mixture ratio of the phosphor. For example, when the mixture ratio is controlled such that opposite ends of the fluorescent tube 112 have a higher color temperature than a middle part a light beam of the lighting device 100 may have an overall warm and mild feeling. Here, the color temperature is controlled by the mixture ratio of the phosphor because the LED 120 and the phosphor are separated from each other. A phosphor surface of the fluorescent tube 112 is disposed over an entire phosphor surface of the LED 120.

The phosphor may be included in the fluorescent tube 112. In other words, the fluorescent tube 112 may be shaped after mixing the phosphor with a raw material of the fluorescent tube 112. Accordingly, the phosphor and the fluorescent tube 112 may be integrally formed.

Alternatively, the phosphor may be disposed in a layer form on a surface of the fluorescent tube 112. In other words, after the fluorescent tube 112 is made of a material not containing the phosphor, the phosphor may be applied on the surface of the fluorescent tube 112. Accordingly, the phosphor may be formed as a thin layer applied on the surface of the fluorescent tube 112.

Hereinafter, although the embodiment will be described such that the phosphor is included in the fluorescent tube 112, the phosphor is neither shown in the drawings nor assigned a reference numeral.

The support member 114 may support the LED 120 and the light guide member 130. In other words, the support member 114 may be connected to opposite ends of the fluorescent tube 112. The LED 120 or the light guide member 130 may be connected to the support members 114. The support members 114 and the fluorescent tube 112 may form a hermetic space for receiving the LED 120 and the light guide member 130.

The support members 114 may each include a power pin 116 for supplying external power to the LED 120. In other words, power input through the power pin 116 may be transmitted to the LED 120. In addition, the power pin 116 may fix the lighting device 100, as a straight-tube fluorescent lamp, to an external structure.

Referring to FIGS. 1 and 2, the LED 120 may be disposed at opposite ends of the fluorescent tube 112. In other words, the LEDs 120 may be disposed in the hermetic space formed by the fluorescent tube 112 and the support member 114 and close to the support members 114. The LEDs 120 disposed at the opposite ends of the fluorescent tube 112 may be connected to the power pins 116 of the support members 114.

Various types of light source may be used as the LED 120. For example, the LED 120 may be an LED package module that emits monochromatic light or white light. In particular, an LED package module emitting monochromatic light may be used. Hereinafter, the embodiment will be described as using an LED package module emitting a blue ray or an ultraviolet (UV) ray as the LED 120, so that the monochromatic light of the LED 120 is converted to white light by the phosphor of the fluorescent tube 112.

When the LED package module emitting the monochromatic light is used, the light of the LEDs 120 may be prevented from being separated into various types of monochromatic light due to a prism effect of the light guide member 130. Thus, the LED package module emitting the monochromatic light may enable flexible arrangement and processing of the light guide member 130 without causing light separation.

Conversely, when an LED package module emitting white light is used, the white light may be separated into various types of monochromatic light due to the prism effect by being refracted, diffused, or reflected by the light guide member 130. As a result, light distribution efficiency of the lighting device 100 may be reduced.

Referring to FIGS. 1 and 2, the light guide member 130 may be configured to distribute the light emitted from the LEDs 120 uniformly to the fluorescent tube 112. The light guide member 130 may be disposed in a hermetic space defined by the fluorescent tube 112 and the support member 114. In addition, the light guide member 130 may be disposed between the LEDs 120 disposed at both ends of the fluorescent tube 112. Ends of the light guide member 130 may be directly connected to or disposed adjacent to the LEDs 120.

The light guide member 130 may be formed of a transparent material for distribution of the light of the LEDs 120. For example, the light guide member 130 may be made of transparent glass or a plastic material.

The light guide member 130 may be configured to have a refractive index reduced in a direction A away from the LEDs 120. In other words, since the refractive index of the light guide member 130 is varied according to positions of the light guide member 130, illumination of the light distributed throughout the light guide member 130 may be controlled to be uniform. In particular, since light of the LED package module has an extremely high property of straightness, a light amount refracted by the light guide member 130 may be increased by configuring the light guide member 130 to have a higher refractive index at positions closer to the LEDs 120.

By varying the refractive index of the light guide member 130 according to positions, light distribution efficiency of the lighting device 100 may be increased. Various examples of the light guide member 130 are illustrated in FIGS. 3 to 5.

Referring to FIG. 3, a light guide member 132 according to one example may be structured by bonding a plurality of light guide materials 132a and 132b having different refractive indices. In other words, the light guide member 132 may include first light guide materials 132a disposed at opposite ends of the fluorescent tube 112 to receive the light of the LEDs 120, and the second light guide material 132b disposed between the first light guide materials 132a and configured to have a lower refractive index than the first light guide materials 132a.

The first light guide materials 132a may be directly connected to or disposed adjacent to the LEDs 120 disposed at the opposite ends of the fluorescent tube 112. Opposite ends of the second light guide material 132b may be bonded to the first light guide materials 132a. However, the light guide member 132 is not limited to include the first light guide materials 132a and the second light guide material 132b. According to a design and conditions of the lighting device 100, the refractive index, a number, a shape of a bonding surface of the light guide materials 132a and 132b may be variably controlled.

Referring to FIG. 4, a light guide member 134, according to another example, may include an uneven surface portion 135 configured to diffuse or reflect light. The shape of the uneven surface portion 135 may be varied according to the design and conditions of the lighting device 100. For example, the uneven surface portion 135 may include a recess and a projection, each having a polygonal or semicircular cross section. The uneven surface portion 135 may be provided in various patterns on a surface of the light guide member 134.

The light guide member 134 shown in FIG. 4 includes the uneven surface portion 135 having a triangular cross section, in addition to the light guide member 132 shown in FIG. 3. When the uneven surface portion 135 is formed on the surface of the light guide member 134, light emitted from the light guide member 134 may be diffused or reflected, thereby increasing light distribution efficiency of the light guide member 134.

The uneven surface portion 135 may be formed on the surface of the light guide member 134 by various methods. For example, the surface of the light guide member 134 may be directly processed, or shaped into the uneven surface portion 135 using a mold including the uneven surface portion 135. Also, the uneven surface portion 135 may be separately formed and attached to the surface of the light guide member 134.

Referring to FIG. 5, a light guide member 136, according to still another example, may include at least one of a bubble body 137 or a reflection body (not shown) disposed in the light guide member 136 to diffuse or reflect the light. The bubble body 137 may include air bubbles. The reflection body may be formed of metal having a high reflectance. The bubble body 137 and the reflection body may be mixed with a raw material of the light guide member 136 or formed, during shaping of the light guide member 136.

A shape, a size, and a distance of the bubble body 137 or the reflection body may be varied according to the design or the conditions of the lighting device 100. For example, the bubble body 137 or the reflection body may be provided in a spherical, conical or pyramidal, or pillar shape, and may be distributed in the light guide member 136 in various patterns.

The light guide member 136 shown in FIG. 5 may include the bubble body 137 arranged at uniform distances, in addition to the light guide member 132 shown in FIG. 3. When the bubble body 137 is formed in the light guide member 136, light emitted along an inside of the light guide member 136 may be diffused or reflected, thereby increasing light distribution efficiency of the light guide member 134.

The operation of the lighting device 100 structured as aforementioned will now be described. Hereinafter, the light guide member 130 shown in FIG. 3 will be described as being applied to the lighting device 100 for a convenient explanation.

First, when power is supplied to the lighting device 100, the power is transmitted to the LEDs 120 disposed at opposite ends of the fluorescent tube 112 through the power pins 116, thereby operating the LEDs 120.

The LEDs 120 emit monochromatic light through the light guide member 130. The light from the LEDs 120 may be incident to an inside of the light guide member 130 through the opposite ends of the light guide member 130.

The light from the LEDs 120 may pass through the first light guide materials 132a disposed at the opposite ends of the light guide member 130, during which the first light guide materials 132a may refract the light from the LEDs 120 by a first refractive index toward the opposite ends of the fluorescent tube 112.

After passing through the first light guide materials 132a, the light may pass through the second light guide material 132a disposed in the middle part of the fluorescent tube 112, during which the second light guide material 132b may refract the light passed through the first light guide materials 132a by a second refractive index toward the middle part of the fluorescent tube 112.

Since the first refractive index is greater than the second refractive index, refraction of the high-straightness light emitted from the LEDs 120 may be efficiently performed. During the refraction, straightness of the light being transmitted to the first light guide materials 132a may be reduced. Accordingly, although the second refractive index of the second light guide material 132b is smaller than the first refractive index, the second light guide material 132b may refract the light by almost the same degree as the first light guide materials 132a.

The light emitted from the light guide member 130 to the fluorescent tube 112 may be emitted by uniform illumination from the entire part of the light guide member 130. As passing through the fluorescent tube 112, the light may be converted into white light by the phosphor.

Since the light emitted from the LEDs 120 is monochromatic light, separation of the light into various types of monochromatic light during refraction by the light guide member 130 may be prevented. Accordingly, stability of light distribution and a degree of freedom in design of the lighting device 100 may be increased. Furthermore, when the light guide member 130 is further provided with the uneven surface portion 135 of FIG. 4, or the bubble body 137 or the reflection body of FIG. 5, to increase the light distribution efficiency, separation of the light into various types of monochromatic light during diffusion or reflection may be prevented.

FIG. 6 is a cross-sectional view illustrating a lighting device 200 according to another embodiment. Since the same or similar reference numerals as illustrated in FIGS. 1 and 2 refer to the same elements in FIG. 6, a detailed description of such elements will be omitted for conciseness. Hereinafter, distinctive features of the lighting device 200 from the lighting device 100 of FIGS. 1 and 2 will be mainly described.

Referring to FIG. 6, the lighting device 200 is different from the lighting device 100 shown in FIGS. 1 and 2 in that refractive indices of a light guide member 230 are varied according to positions by adjusting density of at least one of a bubble body 237 or a reflection body (not shown) disposed in the light guide member 230.

In other words, at least one of the bubble body 237 and the reflection body for diffusing or reflecting the light of the LEDs 120 may be provided in the light guide member 230 to increase light distribution efficiency of the light guide member 230. The bubble body 237 and the reflection body are almost the same structure as the bubble body 137 and the reflection body described with reference to FIG. 5, and therefore will not be described in detail. Hereinafter, the present embodiment will be described as including only the bubble body 237 in the light guide member 230, for a convenient explanation.

When the density of the bubble body 237 is increased, refraction efficiency of the light may be increased. When the density of the bubble body 237 is reduced, refraction efficiency of the light may be reduced. Therefore, the bubble body 237 may be configured to have the density reduced in a direction toward the LEDs 120.

The light guide member 230 shown in FIG. 6 may be divided into a plurality of portions 232 and 234, with reference to distances to the LEDs 120. The divided portions 232 and 234 may be designed to have different densities of the bubble body 237. Thus, instead of bonding the plurality of light guide materials 132a and 132b having different refractive indices as in the light guide member 130 shown in FIG. 3, the present embodiment may adjust the refractive indices of the light guide member 230 by dividing the light guide member 230 into the plurality of portions 232 and 234 and varying the density of at least one of the bubble body 237 and the reflection body.

FIG. 7 is a cross-sectional view illustrating a lighting device 300 according to yet another embodiment. Since the same or similar reference numerals as illustrated in FIGS. 1 and 2 refer to the same elements in FIG. 7, a detailed description of such elements will be omitted. Hereinafter, distinctive features of the lighting device 300 from the lighting device 100 of FIGS. 1 and 2, will be mainly described.

Referring to FIG. 7, the lighting device 300 is different from the lighting device 100 shown in FIGS. 1 and 2 in that thickness of a light guide member 330 is reduced in a direction away from the LEDs 120 in a sloping manner.

In other words, the light guide member 330 may be configured such that an effective refractive index is reduced in a direction away from the LEDs 120. The effective refractive index of the light guide member 330 may be a mean value of refractive indices of all positions from the LEDs 120 to the fluorescent tube 112. In other words, the light from the LEDs 120 may be first refracted by a first refractive index when passing through the light guide member 330, and secondly refracted by a second refractive index when passing through a space between the light guide member 330 and the fluorescent tube 112. The effective refractive index refers to the mean value of the first refractive index and the second refractive index. The effective refractive index may be varied according to gas injected in the space formed by the fluorescent tube 112 and the support members 114.

Since the thickness of the light guide member 330 is different according to the distance to the LEDs 120, the distance between the light guide member 330 and the fluorescent tube 112 is also varied. Accordingly, the effective refractive index may be varied according to positions of the light guide member 330. However, in the lighting device 100 shown in FIGS. 1 and 2, since a thickness of the light guide member 130 is constant irrespective of the distance to the LEDs 120, the distance between the light guide member 130 and the fluorescent tube 112 may be constant. Therefore, the effective refractive index is not considered in the lighting device 100 shown in FIGS. 1 and 2, whereas the lighting device 300 may be designed in FIG. 7 considering the effective refractive index.

As shown in FIG. 7, the light guide member 330 may be in a conical shape or a polygonal pyramid shape. The light guide member 330 may be disposed at each of the LEDs 120 disposed at opposite ends of the fluorescent tube 112. In other words, the light guide member 330 may include a first light guide member 332 provided to the LED 120 disposed at one end of the fluorescent tube 112, and a second light guide member 334 provided to the LED 120 disposed at the opposite end of the fluorescent tube 112.

A vertex portion of the light guide member 330 may be disposed to be far from the LEDs 120. A bottom surface portion of the light guide member 330 may be directly connected to or disposed adjacent to the LEDs 120. Here, vertex portions of the first light guide member 332 and the second light guide member 334 may be interconnected or separated by a predetermined distance.

The light from the LEDs 120 may be refracted by slant surfaces 332a and 334a of the light guide member 330. In other words, the slant surfaces 332a and 334a may correspond to refraction surfaces for refracting the light to the fluorescent tube 112.

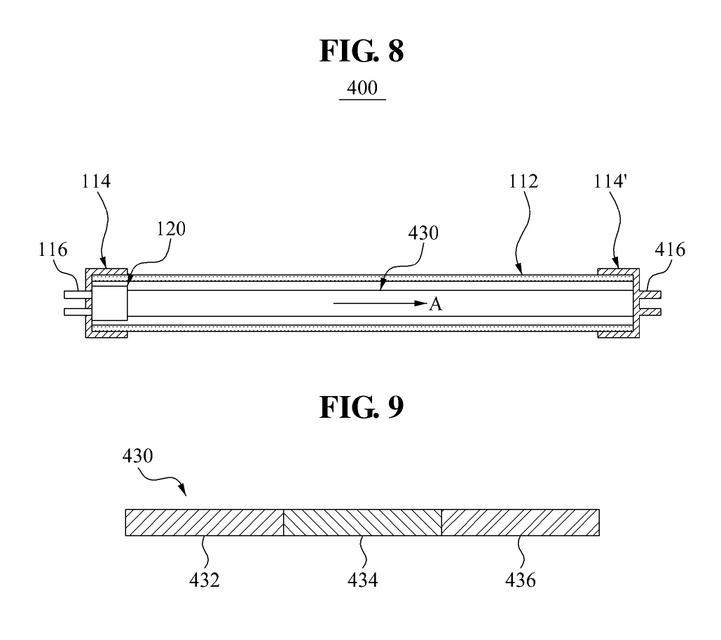

FIG. 8 is a cross-sectional view illustrating a lighting device 400 according to still another embodiment. FIG. 9 is a sectional view illustrating a light guide member shown in FIG. 8.

Since the same or similar reference numerals as illustrated in FIGS. 1 and 2 refer to the same elements in FIGS. 8 and 9, a detailed description of such elements will be omitted. Hereinafter, distinctive features of the lighting device 400 from the lighting device 100 of FIGS. 1 and 2 will be mainly described.

Referring to FIGS. 8 and 9, the lighting device 400 is different from the lighting device 100 shown in FIGS. 1 and 2 in that the LED 120 is disposed at only one end of the fluorescent tube 112.

Therefore, a light guide member 430 according to the present embodiment may include a first light guide material 432 disposed at one end of the fluorescent tube 112 of a device main body 410 to receive light of the LED 120, a second light guide material 434 bonded to an end of the first light guide material 432 and configured to have a lower refractive index than the first light guide material 432, and a third light guide material 436 disposed at the opposite end of the fluorescent tube 112 and configured to have a lower refractive index than the second light guide material 434.

A support member 114′, different from the support member 114 shown in FIGS. 1 and 2, may be mounted to the opposite end of the fluorescent tube 112. In other words, since the support member 114′ shown in FIG. 8 does not have to supply power to the LED 120, the power pin 116 illustrated in FIGS. 1 and 2 may be omitted. Instead of the power pin 116, a projection 416, in a similar shape to the power pin 116, may be formed.

Although a few exemplary embodiments have been shown and described, embodiments are not limited to the described exemplary embodiments. Instead, it would be appreciated by those skilled in the art that changes may be made to these exemplary embodiments without departing from the principles and spirit of the embodiments, the scope of which is defined by the claims and their equivalents.

What is claimed is:

1. A lighting device comprising:
a device main body;
a light emitting diode (LED) which is provided in at least one end of an inside of the device main body; and
a light guide member which is disposed between both ends of the device main body to uniformly distribute light emitted from the LED to the outside,
wherein a refractive index of the light guide member is reduced in a direction away from the LED.

2. The lighting device of claim 1, wherein the light guide member is formed by bonding a plurality of light guide materials having different refractive indices.

3. The lighting device of claim 2, wherein
the LED is disposed at the both ends of the device main body, and
the light guide member comprises:
a first light guide material which is disposed at each end of the lighting device to receive the light emitted from the LED; and
a second light guide material, disposed between the first light guide material disposed at each end of the lightning device, to be bonded to the first light guide material at each end of the lightning device, the second light guide material has a lower refractive index than the first light guide material.

4. The lighting device of claim 2, wherein
the LED is disposed at the at least one end of the device main body, and
the light guide member comprises:
a first light guide material which is disposed at one end of the lighting device to receive the light emitted from the LED;
a second light guide material which is bonded to one end of the first light guide material, the second light guide material having a lower refractive index than the first light guide material; and
a third light guide material bonded to an end of the second light guide material and disposed at an opposite end of the device main body, the third light guide material has a lower refractive index than the second light guide material.

5. The lighting device of claim 1, wherein the light guide member comprises an uneven surface portion disposed on a surface to diffuse or reflect the light to increase light distribution efficiency.

6. The lighting device of claim 1, wherein the light guide member comprises at least one of a bubble body and a reflection body disposed at an inside of the light guide member to diffuse or reflect the light to increase light distribution efficiency.

7. The lighting device of claim 1, wherein
the light guide member comprises at least one of a bubble body and a reflection body disposed at an inside of the light guide member to diffuse or reflect light from the LED to increase light distribution efficiency of the light guide member, and
at least one of the bubble body and the reflection body is configured to have a density varying according to positions of the light guide member so that a refractive index is varied according to the positions of the light guide member.

8. The lighting device of claim 7, wherein the density of the at least one of the bubble body and the reflection body is reduced in a direction away from the LED.

9. The lighting device of claim 1, wherein the light guide member is sloped to have a reduced thickness in the direction away from the LED such that an effective refractive index is reduced in a direction away from the LED.

10. The lighting device of claim 9, wherein the light guide member is provided in a conical shape or a polygonal pyramid shape.

11. The lighting device of claim 1, wherein
the device main body comprises:
a fluorescent tube which is configured to receive the LED and the light guide member inside; and
a support member which is connected to the both ends of the fluorescent tube to support the light guide member,
the LED is configured to emit monochromatic light, and
a phosphor converts the monochromatic light to white light.

12. The lighting device of claim 11, wherein the fluorescent tube comprises the phosphor.

13. The lighting device of claim 11, wherein the phosphor is provided in a layer form on a surface of the fluorescent tube.

14. A lighting device comprising:
a device main body;
a light emitting diode (LED) which is provided in at least one end of an inside of the device main body; and
a light guide member which is disposed between both ends of the device main body to uniformly distribute light emitted from the LED to the outside,
wherein the device main body comprises:
a fluorescent tube is configured to receive the LED and the light guide member inside and is provided with a phosphor for converting monochromatic light to white light; and
a support member connected to the both ends of the fluorescent tube to support the light guide member.

15. The lighting device of claim 14, wherein the fluorescent tube comprises the phosphor.

16. The lighting device of claim 14, wherein the phosphor is provided in a layer form on a surface of the fluorescent tube.

17. A lighting device comprising:
a light emitting diode (LED);
a light guide member which is configured to uniformly distribute light;
an elongated cylinder which is configured to comprise the LED and the light guide member;
a first support member which is connected to one end of the elongated cylinder to support the light guide member; and
a second support member which is connected to an opposite end of the elongated cylinder, as compared to the one end of the elongated cylinder,
wherein the LED is disposed at the one end of the elongated cylinder.

18. The lightning device of claim 17, wherein the light guide member comprises:
a first light guide material which is disposed at the one end of the elongated cylinder to receive light of the LED;
a second light guide material which is bonded to an end of the first light guide material; and
a third light guide material which is disposed at the opposite end of the elongated cylinder.

19. The lighting device of claim 18, wherein the second light guide material is configured to have a lower refractive index than the first light guide material, and the third light guide material is configured to have a lower refractive index than the second light guide material.

20. The lightning device of claim 17, wherein the elongated cylinder is provided with a phosphor for converting monochromatic light to white light.
